(19) United States
(12) Patent Application Publication
(10) Pub. No.: US 2026/0078047 A1
(43) Pub. Date: Mar. 19, 2026

(54) ROBOTIC BLOW MOLD LUBRICATION

(71) Applicant: Owens-Brockway Glass Container Inc., Perrysburg, OH (US)

(72) Inventors: Paul Mohr, Waterville, OH (US); Troy Herring, Whitehouse, OH (US); Brock Hoops, Maumee, OH (US); Jason Adams, Wake Forest, NC (US); Marco Veri, Velaine sur Sambre (BE); Jérémie Federico, Godarville (BE); Michele Terranova, Moignelée (BE); Yusuf Karaca, Verviers (BE)

(21) Appl. No.: 19/098,351

(22) Filed: Apr. 2, 2025

Related U.S. Application Data
(60) Provisional application No. 63/695,827, filed on Sep. 17, 2024.

(51) Int. Cl. C03B 40/027

(52) U.S. Cl. CPC C03B 40/027

(57) ABSTRACT

A robotic mold lubrication system includes a robot that is translatable along a blow side of an individual section glass container forming machine and a mold spray tool carried by the robot. The mold spray tool includes at least one set of nozzles. To lubricate one or more target blow molds of one or more of the individual sections of the forming machine, the robot is translated to the designated individual section, the mold spray tool is moved by operation of the robot to the target blow mold(s), and the target blow molds are lubricated by applying the lubricant to the target blow mold(s) from the mold spray tool. The robot may acquire the mold spray tool from, and return the mold spray tool to, a trolley that is translated along the blow side of the forming machine along with the robot.

### TECHNICAL FIELD

This disclosure relates to glass container forming systems and, more particularly, to equipment for lubricating one or more blow molds of a glass container forming machine.

### BACKGROUND

In the manufacture of glass containers, a glass melting apparatus, such as a continuous melting furnace or a submerged combustion melter, produces molten glass by melting a vitrifiable feed or “batch” material. The produced molten glass is refined or fined either within the glass melting apparatus or in a separate device to remove entrained gas bubbles from the molten glass and the refined/fined molten glass is then conditioned in a forehearth to thermally homogenize the glass and to bring the glass to a viscosity suitable for downstream forming operations. A glass feeder is typically appended to the end of the forehearth and is operable to repetitively form discrete portions of molten glass, which are conventionally known as “glass gobs,” from the molten glass supplied by the forehearth. The feeder may, for example, produce a single glass gob at a time or it may produce multiple glass gobs simultaneously. Each glass gob, upon being formed, drops from the glass feeder and is delivered to a glass container forming machine where the gob is formed into a glass container. The glass gobs may be delivered to the glass container forming machine through an interconnected series of scoops, troughs, and deflectors, or by some other delivery approach.

The most common and widespread glass container forming machine in use today is known as the individual section (IS) glass container forming machine. The IS forming machine includes multiple individual sections of identical construction positioned side-by-side in a longitudinal row and configured to be operated out of phase with one another to provide a continuous flow of glass containers on a conveyor that runs alongside of the IS forming machine. Each section of the IS forming machine includes a blank station that includes one or more blank molds and a blow station that includes one or more blow molds. The one or more blank molds in the blank station of each section continually receive glass gobs delivered from the glass feeder and form the glass gobs into partially-formed containers or “parisons.” The parisons, once formed, are transferred from the blank station of the section to the blow station and are formed within the corresponding one or more blow molds into glass containers. More specifically, in the blow station, each blow mold includes two opposed and separable blow mold halves and a bottom plate that cooperate to define a blow mold cavity. During a typical machine cycle, the blow mold halves of each blow mold are separated from each other and the bottom plate as the parison is located therebetween. Once the parison is in place, the blow mold halves are closed into engagement with each other and the bottom plate to enclose at least a large portion of the parison within the blow mold cavity so that the parison can be blown into the glass container.

Various portions of the IS forming machine are periodically lubricated to help keep the machine operating as intended and to ensure the continuous manufacture of quality glass containers. On the blow side of the IS forming machine, the blow mold(s) of each section have conventionally been lubricated between machine cycles (e.g., after the glass container(s) from that section have been removed and prior to delivery of the next parison(s) to the section) while the blow mold halves are in an open position. The procedure for applying the lubricant to the blow mold(s) often involves dipping a lubricating brush into a viscous lubricant and manually swabbing the interior mold surfaces of the mold halves and the bottom plate with the lubricating brush. While generally workable, manual lubrication is labor intensive and relies heavily on the skill and experience of the machine operator performing the lubrication. Additionally, manual lubrication by nature is susceptible to inconsistency and unpredictable variability between lubricating events and, further, it is difficult if not impossible to selectively and precisely apply the lubricant to certain portions of the blow mold halves and/or the bottom plate that may need to be lubricated more or less frequently due to the contour of the interior mold surfaces.

### SUMMARY

A robotic mold lubrication system, a mold spray tool, and a method of lubricating one or more blow molds of an individual section glass container forming machine are disclosed. The robotic mold lubrication system includes a robot that carries a mold spray tool having at least one set of nozzles. The set of nozzles of the mold spray tool preferably includes a first nozzle, a second nozzle, and a third nozzle with each nozzle being configured to apply a lubricant onto one of an interior surface of a first blow mold half, an interior surface of a second blow mold half, and an interior surface of a bottom plate. Each set of nozzles carried by the mold spray tool is employed to lubricate a different blow mold if the designated individual section includes more than one blow mold being lubricated by the mold spray tool. During a lubrication cycle, the robot is brought to a designated individual section that includes one or more target blow molds specified for lubrication and the robot is operated to move the mold spray tool to the target blow mold(s). A lubricant is then applied to the target blow mold(s) from the corresponding set of nozzles. The robotic mold lubrication system may also include a trolley having a spray tool docking station at which the mold spray can be retained. The trolley may be translated along the blow side of the forming machine with the robot so that the mold spray tool can be acquired from, and returned to, the trolley by the robot.

### BRIEF DESCRIPTION OF THE DRAWINGS

FIG. 1 is a front, fragmentary, schematic view of a glass container forming system that includes a robotic mold lubrication system according to an embodiment of the present disclosure.

FIG. 2 is a plan, fragmentary, schematic view of the robotic mold lubrication system of FIG. 1 illustrating a rail, a robot carriage translatable along the rail, and a robot and a trolley carried by the robot carriage along the rail according to an embodiment of the present disclosure.

FIG. 3 is a fragmentary, schematic side view of the robotic mold lubrication system of FIG. 1.

FIG. 4 is an enlarged, fragmentary, schematic side view of the robotic mold lubrication system of FIG. 1.

FIG. 5A is a perspective fragmentary view of a robot of the robotic mold lubrication system of FIG. 1 carrying a mold spray tool having nozzles and showing nozzle spray patterns according to an embodiment of the present disclosure.

FIG. 5B is a schematic sectional view of the mold spray tool of FIG. 5A applying a lubricant to a target blow mold.

FIG. 5C is a perspective view of a mold spray tool having nozzles and showing spray patterns according to another embodiment of the present disclosure.

FIG. 5D is a schematic sectional view of the mold spray tool of FIG. 5C applying a lubricant to a target blow mold.

FIG. 6 is a perspective view of a nozzle and a nozzle valve that may be included in the mold spray tool according to various embodiments of the present disclosure.

FIG. 7 is a perspective view of the nozzle valve of FIG. 6.

FIG. 8 includes schematic views of different types of nozzle configurations and spray patterns.

FIG. 9 is a schematic view of the robotic mold lubrication system of FIG. 1 and an individual section glass container forming machine.

FIG. 10A is a perspective view of a portion of the robot and the trolley of the robotic mold lubrication system of FIG. 1.

FIG. 10B is a further enlarged, fragmentary, perspective view of portions of a hydraulic subsystem and a pneumatic subsystem of FIG. 10A.

FIG. 11 includes schematic views of the robot approaching and coupling to a mold spray tool at a spray tool docking station and thereafter moving the mold spray tool away from the spray tool docking station according to an embodiment of the present disclosure.

FIG. 12 is a schematic side view of a robot coupler and a tool coupler according to an embodiment of the present disclosure.

FIG. 13 is a schematic plan view of the robot and tool couplers and further includes a fluid schematic illustrating one example of how the couplers are supplied with lubricant and pressurized air during operation of the robotic mold lubrication system.

FIG. 14 is a fluid schematic showing various fluid paths between the tool coupler of the mold spray tool and a set of three nozzles of the mold spray tool.

FIG. 15 is a flow chart of a method of lubricating a blow mold.

### DETAILED DESCRIPTION

A robotic mold lubrication system for an individual section (IS) glass container forming machine comprising a plurality individual sections may be operated to lubricate one or more blow molds. Each section of the IS forming machine includes one or more blank molds on a blank side of the machine and one or more blow molds on a blow side of the machine. Each blank mold is designed to accommodate the formation of a molten gob of glass into an inverted parison within a blank mold cavity using the pressing force of a plunger that is extendible into the blank mold cavity through the neck ring or by using a pressurized gas. Each blow mold, on the other hand, is designed to accommodate the formation of the parison into a glass container within a blow mold cavity using a pressurized gas. The blow mold cavity of the blow mold is typically larger in volume than the blank mold cavity of the associated blank mold and often entails more intricate surface contours and finishing details that need to be reflected in the finished glass container. The robotic mold lubrication system described here, which includes a robot that carries a mold spray tool, operates on the blow side of the IS forming machine to lubricate the blow mold(s) within one or more individual sections of the machine. To support the blow side of the full IS forming machine, the robot is carried by a robot carriage that is traversable along a rail between the individual sections of the IS forming machine.

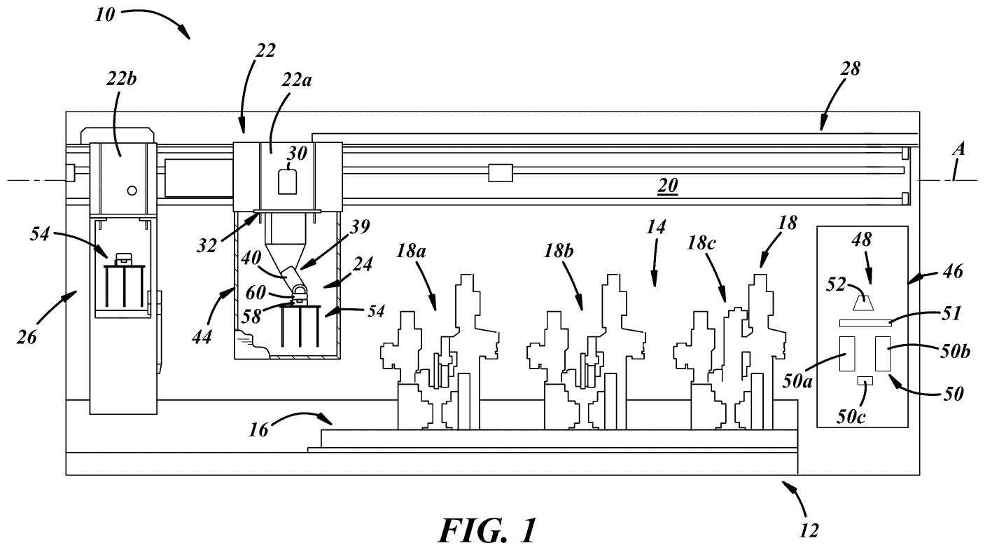

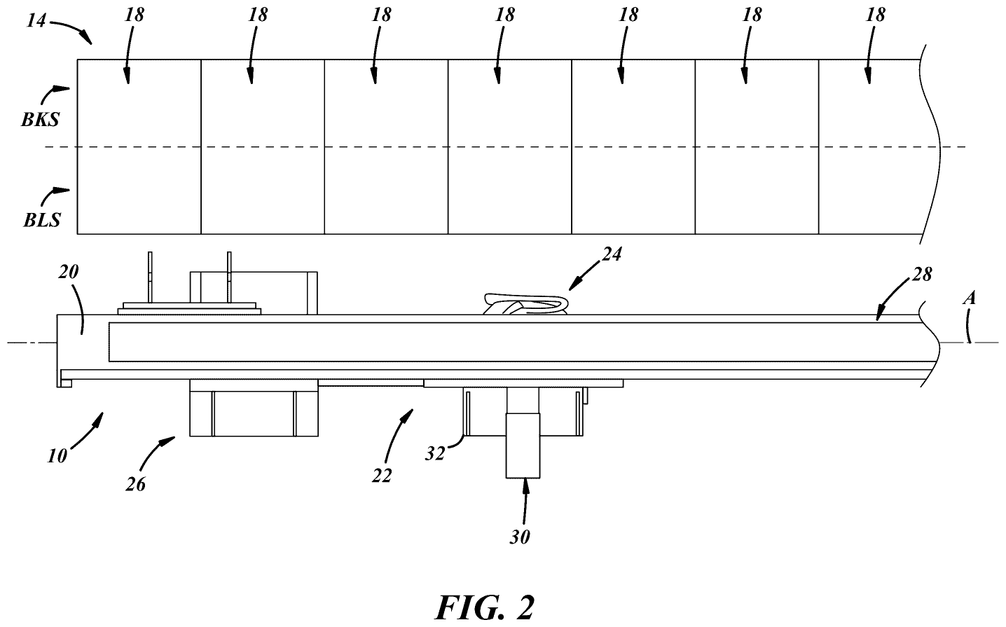

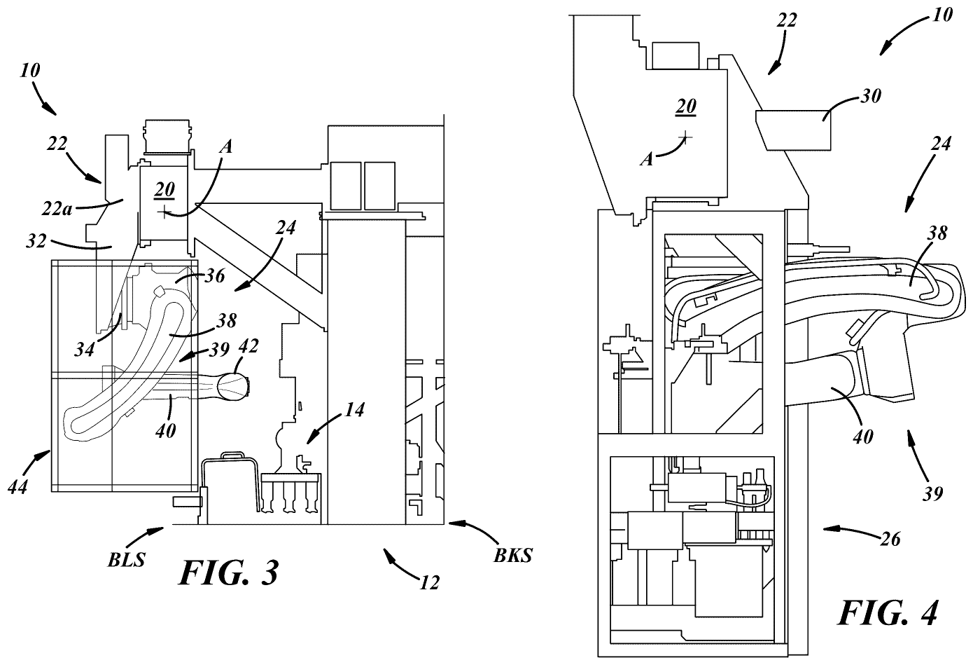

Referring now to FIGS. 1-4, and according to an embodiment of the present disclosure, a robotic mold lubrication system 10 is illustrated. The robotic mold lubrication system 10 is part of a glass container forming system 12 that includes an individual section (IS) glass container forming machine 14 that forms glass containers from gobs of molten glass. The IS forming machine 14 includes a machine base 16 (FIG. 1) and a plurality of individual sections 18 carried by the machine base 16. While three individual sections 18a, 18b, 18c are illustrated here, it is understood that the IS forming machine 14 could include more or less individual sections 18 considering the fact that a typical IS forming machine often includes anywhere from two to twelve sections 18. The individual sections 18 of the IS forming machine 14 are positioned side-by-side in a longitudinal row and each of the sections 18 includes a blank station having one or more blank molds and a blow station having one or more blow molds. The blank stations of the plurality of sections 18 are arranged in a row on one on side of the IS forming machine 14, which is referred to as a blank side BKS (FIG. 3), and the blow stations are arranged in a row on an opposite side of the IS forming machine 14, which is referred to as a blow side BLS (FIG. 3).

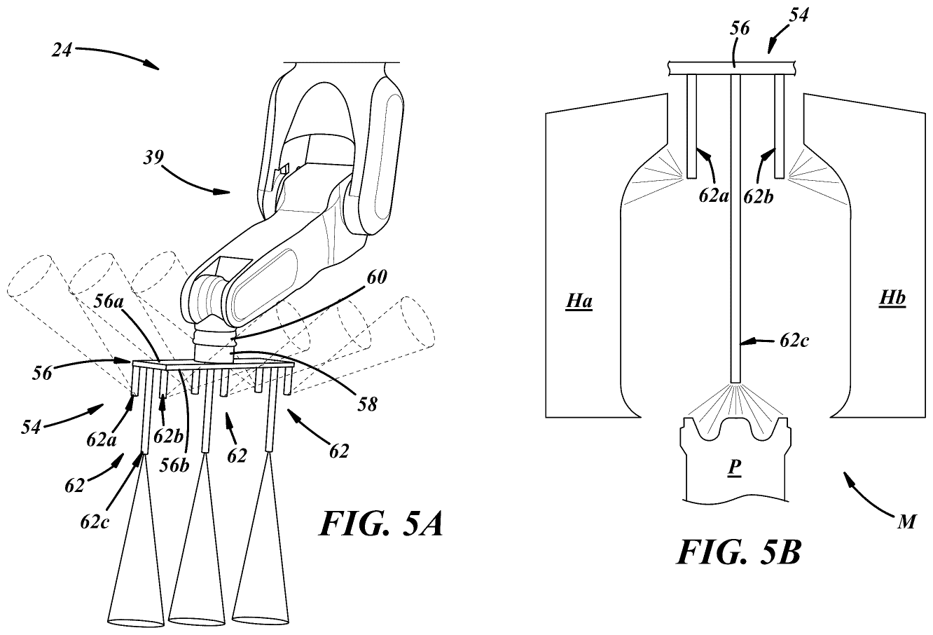

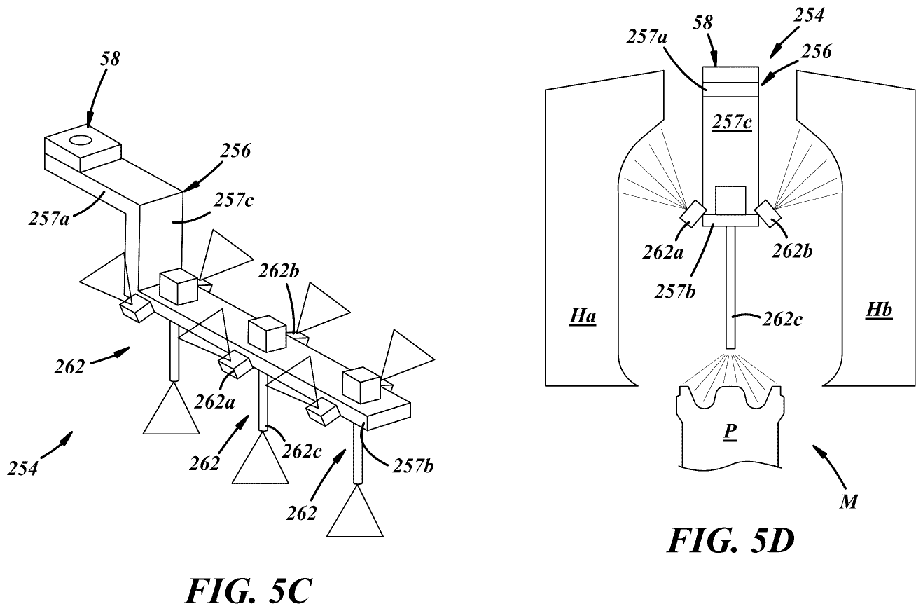

The robotic mold lubrication system 10 extends along the IS forming machine 14 adjacent to the blow side BLS of the machine 14. The robotic mold lubrication system 10 includes a rail 20, a robot carriage 22 carried on and moveable along the rail 20, a robot 24 carried by the robot carriage 22 to carry and manipulate one or more mold spray tools for lubricating one or more blow molds M (FIG. 5B), and a trolley 26 carried by the robot carriage 22 to carry other portions of the system 10 as will be described below. The robotic mold lubrication system 10 is used to apply a lubricant, such as a spray of a lubricating oil, to one or more of the blow molds M of the IS forming machine 14. The lubricant can be applied selectively to any portion of the blow mold(s) M of each individual section 18 and allows for a deliberate and tailored approach to lubricating the blow molds M that can be customized to the particular design of the blow molds M. For example, it may be desirable to selectively apply more or less lubricant to one blow mold portion relative to another blow mold portion, to selectively apply lubricant in different patterns to different blow mold portions, or to selectively apply lubricant in other ways to different blow mold portions. Such customized selective lubrication is not achievable nor practical with current manual blow mold lubrication techniques.

The rail 20 is arranged above, and extends longitudinally along, the blow side BLS of the IS forming machine 14 from a first end of the rail 20 to a second end of the rail 20 down a rail axis A. The rail 20 may be supported by one or more structural posts or beams (not shown) of a factory building, by the IS forming machine 14, or by some other portion of the glass container forming system 12. The rail 20 is configured to support the weight of the robot carriage 22, the robot 24, and the trolley 26, plus any other components of the system 10, and is configured to permit the robot carriage 22 to translate bidirectionally relative to an along the rail 20. A utility or cable chain 28 may be connected to the rail 20. The utility chain 28 includes utilities (not separately shown) such as electrical power cables, electrical communication wires, pneumatic supply conduits, and hydraulic supply conduits, each of which may be coupled to equipment within the system 10, such as the robot 24 and/or the trolley 26, at one end and to any suitable utility couplings at the other end.

The robot carriage 22 includes a robot portion 22a and a trolley portion 22b connected to the robot portion 22a. The robot portion 22a is preferably spaced longitudinally from the trolley portion 22b although, in other embodiments, the two portions 22a, 22b may be disposed immediately adjacent to each other. The robot carriage 22 may be movably supported on the rail 20 by wheels, rollers, bearings, or any other guide elements (not separately shown). The robot carriage 22 is also preferably drivable along the rail 20 by a drivetrain having a carriage motor 30, which may include a drive gear traversable along a gear rack carried by the rail 20, so that the robot carriage 22 can be driven along the rail 20 in either direction between the first and second ends of the rail 20. The carriage motor 30 may be an electrical motor, such as a servo motor, or a fluid motor, such as a pneumatic or hydraulic motor and, in any case, may be provided with utilities via the cable chain 28 or in any other suitable manner.

The robot 24 is supported by the robot portion 22a of the robot carriage 22 and, as shown best in FIGS. 1-3, is preferably suspended from the robot portion 22a vertically between the rail 20 and the blow side BLS of the IS forming machine 14. The robot 24 may, for example, be coupled to a vertically downward extending robot mount 32 (FIG. 3) of the robot carriage 22. The robot 24 includes a robot base 34 coupled to a corresponding surface of the robot mount 32, a shoulder 36 rotatably coupled to the base 34, a robotic arm 39 that may include an upper arm 38 pivotably coupled to the shoulder 36 and a lower arm 40 pivotably coupled to the upper arm 38, and a wrist 42 rotatably coupled to the lower arm 40. The robot 24 may be configured to rotate about a base swivel axis (S-axis), pivot the upper arm 38 about an upper arm axis, pivot the lower arm 40 about an elbow axis, pivot the wrist 42 about a wrist pitch axis, rotate the wrist 42 about a wrist yaw axis, and pivot an end of the wrist 42 about a wrist roll axis, to establish six degrees of freedom. In other embodiments, the robot 24 may have any other suitable quantity of arms and axes that allows the robot 24 to articulate. The robot 24 may include various servomotors to facilitate rotating and pivoting the various portion of the robot 24 about the various axes. Moreover, as shown best in FIG. 3, a robot shroud 44 that partially surrounds the robot 24 may be carried by the robot portion 22a of the robot carriage 22. The robot shroud 44 may have top and bottom walls, upstream and downstream side walls, and a back wall, and may define an open front window opposite the back wall that faces the IS forming machine 14 and out of which the robot 24 can extend towards the machine 14.

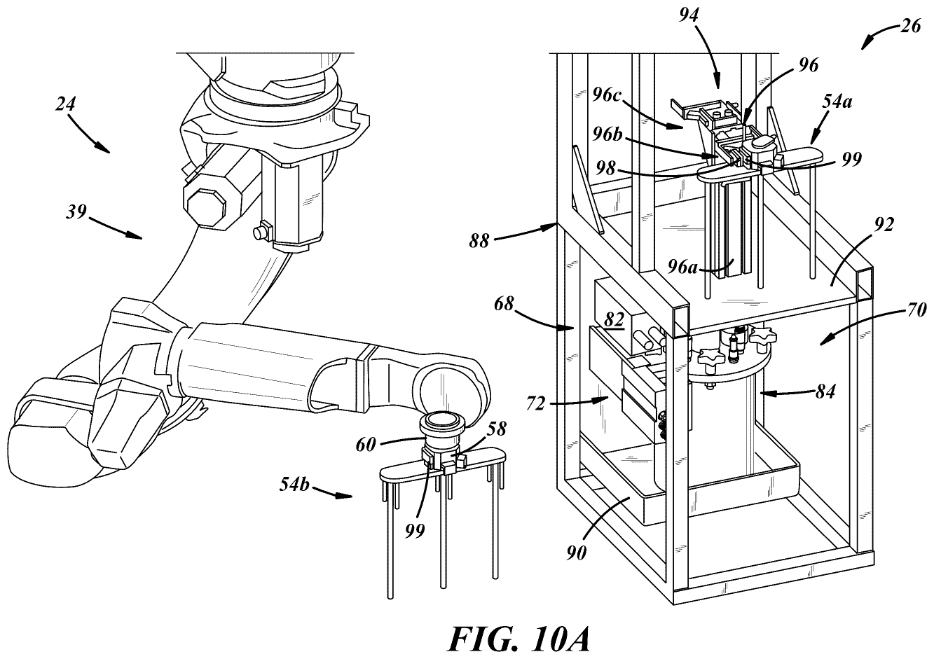

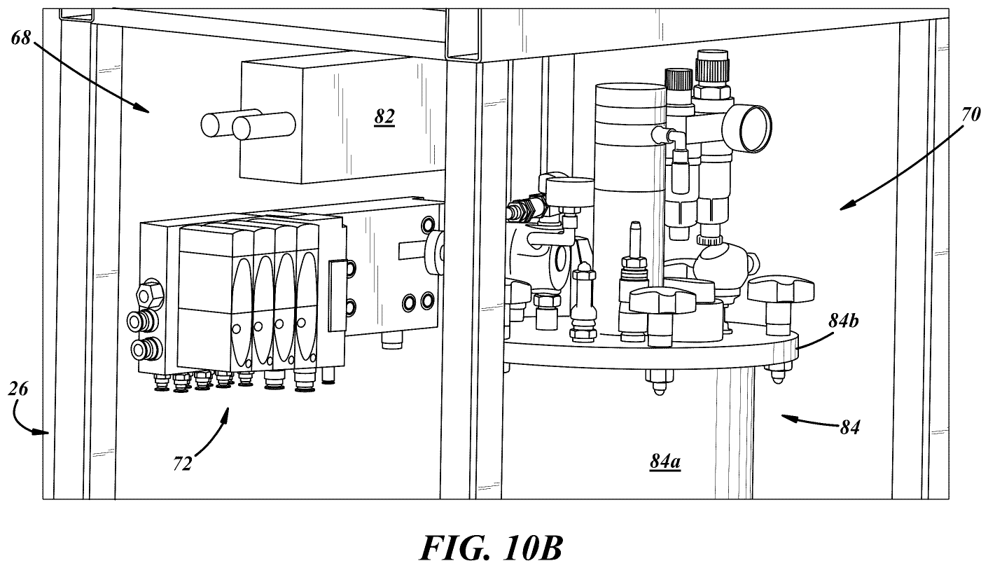

The robot 24 employs a mold spray tool 54 as shown in FIGS. 5A-5B to apply the lubricant to the blow mold(s) M. The mold spray tool 54 is carried by and manipulatable by the robotic arm 39 of the robot 24. Specifically, in this embodiment, the mold spray tool 54 is carried by the wrist 42 of the robotic arm 39 and, thus, the tool 54 can be raised, lowered, pivoted, tilted, and/or articulated according to the six degrees of freedom of the robot 24. The mold spray tool 54 is operable to lubricate the one or more blow molds M in each section 18 of the IS forming machine 14 at the designated time. Indeed, for any particular section 18 of the IS forming machine 14, the mold spray tool 54 may spray a lubricant onto any or all of the following portions of a blow mold M as illustrated in FIGS. 5A-5B: a first (or “left”) blow mold half Ha, a second (or “right”) blow mold half Hb, and a bottom plate P. The mold spray tool 54 shown here includes a support base 56, which, as shown, may be a planar plate that has a coupler side 56a and a nozzle side 56b opposite the coupler side 56a. The mold spray tool 54 also includes a tool coupler 58 secured to the support base 56 and at least one set of nozzles 62 carried by the support base 56. The tool coupler 58 may be secured to the coupler side 56a of the support base 56 and the at least one set of nozzles 62 may be carried by and extend away from the nozzle side 56b of the support base 56. The tool coupler 58 is connectable to the robot 24. More specifically, for example, and as explained in more detail below, the tool coupler 58 is couplable to a robot coupler 60 of the robot 24 (FIGS. 10A and 11-13), which is carried by the robotic arm 39, for instance, by the wrist 42.

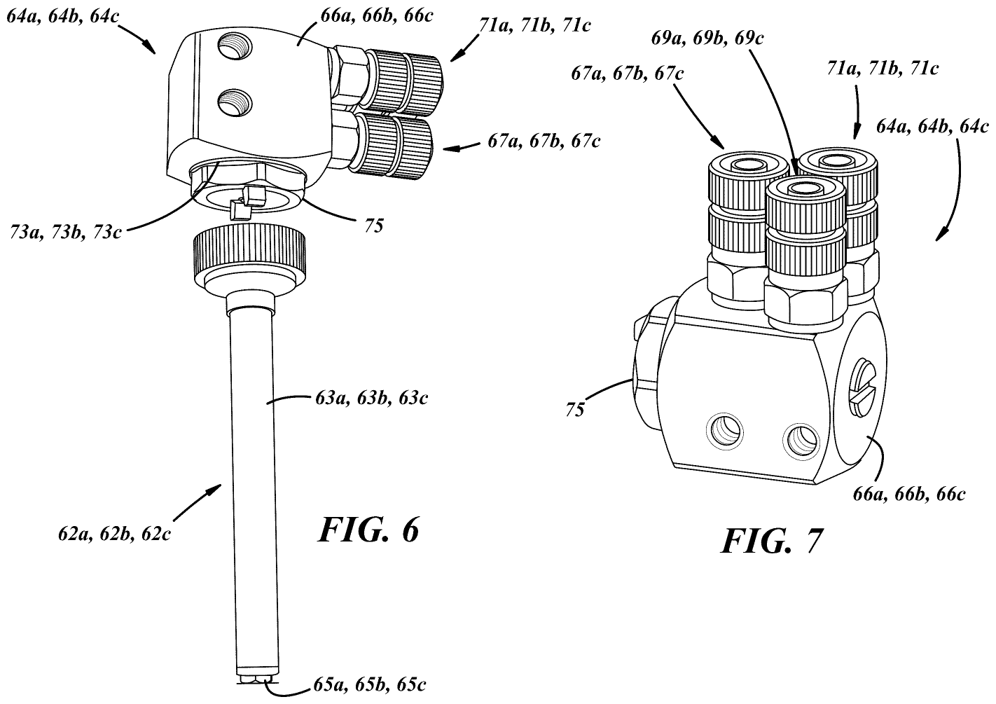

Each set of nozzles 62 is in downstream fluid communication with the tool coupler 58 and may include three nozzles as follows: a first or “left” nozzle 62a, a second or “right” nozzle 62b, and a third or “bottom” nozzle 62c. The nozzles 62a, 62b, 62c include elongated nozzle bodies 63a, 63b, 63c that support distal spray tips 65a, 65b, 65c at axial free ends of the bodies 63a, 63b, 63c, as shown in FIG. 6, and each nozzle 62a, 62b, 62c may be composed of carbon, aluminum, or any other suitable material. The bottom nozzle 62c may be positioned between the left and right nozzles 62a, 62b, for example, centrally between the left and right nozzles 62a, 62b. The bottom nozzle 62c may be longer than the left and right nozzles 62a, 62b, and the left and right nozzles 62a, 62b may be the same length or may be of different lengths from one another. Although the nozzles 62a, 62b, 62c of each set are illustrated as being aligned in a row extending transverse to a longitudinal axis of the support base 56, the nozzles 62a, 62b, 62c could be linearly aligned with one another but offset at an oblique angle with respect to the longitudinal axis of the support base 56, or the nozzles 62a, 62b, 62c could be arranged in a triangular shaped arrangement or in any other arrangement suitable for a particular spraying application. While the mold spray tool 54 is illustrated as carrying a plurality of sets of nozzles 62, e.g., three sets of the nozzles 62, it may include only one set, two sets, or any suitable quantity of sets of the nozzles 62 depending on a quantity of blow molds M in the section(s) 18 of the IS forming machine 14 being lubricated.

For a given blow mold M being lubricated, the mold spray tool 54 is configured so that lubricant is independently controllably sprayable from each of the nozzles 62a, 62b, 62c. This allows each nozzle 62a, 62b, 62c to spray the lubricant onto an interior surface of a different one of the blow mold portions Ha, Hb, P. In a specific example, and with reference to FIG. 5B, the bottom nozzle 62c may be configured to spray the interior surface of the bottom plate P with a lubricant, and the left and right nozzles 62a, 62b may be configured to spray the interior surface of the left blow mold half Ha and the interior surface of the right blow mold half Hb with a lubricant, respectively, including shoulder portions of the blow mold halves Ha, Hb and any portions of the blow mold halves Ha, Hb that include embossments or debossments. Even more specifically, each of the nozzles 62a, 62b, 62c may be configured to spray a different volume of a lubricant, and/or to spray a lubricant according to a different spray pattern, and/or to spray a lubricant according to a different lubrication schedule. For example, the left and right nozzles 62a, 62b may spray the interior surfaces of their respective blow mold halves Ha, Hb within the shoulder portions of the mold halves Ha, Hb every lubrication cycle but spray the remainder of their respective interior surfaces less frequently, and the bottom nozzle 62c may spray the interior surface of the bottom plate P on its own specific schedule. The mold spray tool 54 may be translated orthogonally, vertically, horizontally, obliquely, and/or diagonally, in any direction(s) suitable for spraying the blow mold M, and/or may be rotated, swiveled, rocked, tilted, pivoted, articulated, oscillated, or otherwise moved in any suitable manner according to the six degrees of freedom of the robot 24, to spray the lubricant however desired within the blow mold M.

With reference now to FIGS. 6 and 7, the mold spray tool 54 includes a nozzle valve 64a, 64b, 64c for each of the nozzles 62a, 62b, 62c, and each of the nozzles 62a, 62b, 62c connects to and fluidly communicates with its associated nozzle valve 64a, 64b, 64c. Each nozzle valve 64a, 64b, 64c includes a valve body 66a, 66b, 66c having a lubricant inlet port 67a, 67b, 67c, an atomizing air inlet port 69a, 69b, 69c, an activation air inlet port 71a, 71b, 71c, and an outlet port 73a, 73b, 73c. The valve body 66a, 66b, 66c of each nozzle valve 64a, 64b, 64c may include threaded fastener holes to facilitate mounting the valve body 66a, 66b, 66c to the support base 56 (FIG. 5A) or to mounting brackets that may be welded, fastened, or otherwise coupled to the support base 56, or via any other fastening, welding, or other coupling arrangement with respect to the support base 56. The lubricant inlet ports 67a, 67b, 67c, 69a, 69b, 69c, 71a, 71b, 71c of each valve nozzle 64a, 64b, 64c may be established by quick disconnect fittings as illustrated and the outlet port 73a, 73b, 73c may releasably receive its corresponding nozzle 62a, 62b, 62c such as, for example, by a threaded connection. The nozzles 62a, 62b, 62c may be replaceable. For example, FIGS. 6 and 7 each show an adjustable flat spray nozzle 75 threaded to the outlet port 73a, 73b, 73c of the valve body 66a, 66b, 66c; however, the adjustable flat spray nozzle 75 may be unthreaded from the outlet port 73a, 73b, 73c and one of the nozzles 62a, 62b, 62c illustrated in FIGS. 5A and 5B (also shown in FIG. 6) may instead be connected to the valve body 66a, 66b, 66c simply by threading the nozzle 62a, 62b, 62c to the outlet port 73a, 73b, 73c.

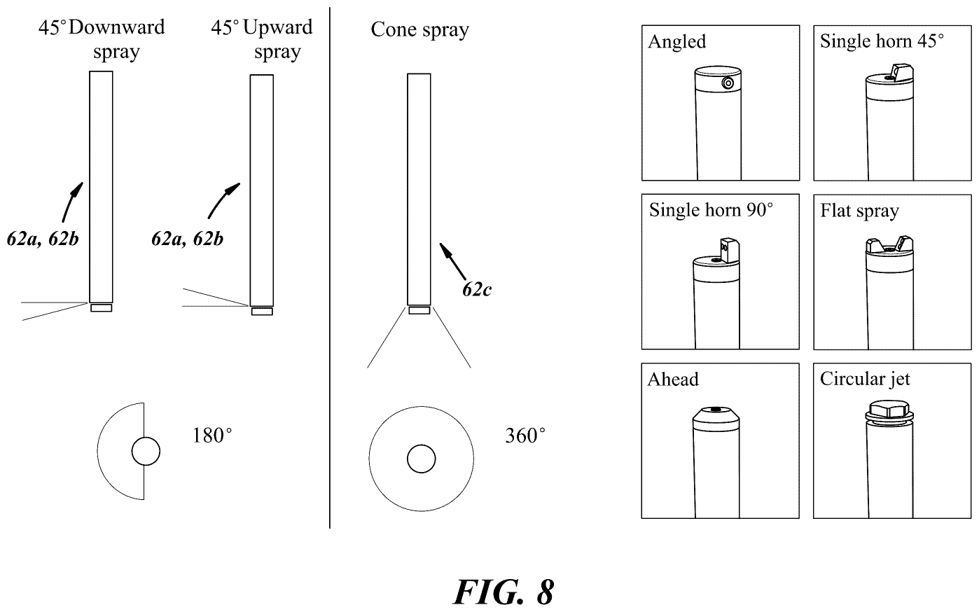

For each of the one or more sets of nozzles 62, and with reference now to FIG. 8, the bottom nozzle 62c may be configured to emit an axial spray pattern from its distal spray tip 65c, and the left and right nozzles 62a, 62b may be configured to emit lateral spray patterns, for example, in sideways and upwards or downwards oblique orientations as shown from their respective distal spray tips 65a, 65b. In a more specific example, the spray tip 65c of the bottom nozzle 62c may spray an axially downwardly extending conical spray pattern that extends 360 angular degrees about a circumference of the nozzle 62c, and the spray tips 65a, 65c of each of the left and right nozzles 62a, 62b may spray a 45 angular degree or less upward or downward lateral spray pattern that sprays 180 angular degrees or less about a circumference of the nozzle 62a, 62c. The nozzles 62a, 62b, 62c may include different spray tips 65a, 65b, 65c to establish these different spray patterns. Indeed, as also shown on FIG. 8, the spray tips 65a, 65b, 65c of the nozzles 62a, 62b, 62c may be configured as shown to achieve the following various spray patterns: angled, single horn 90°, ahead, circular jet, flat spray, and single horn 45°.

Referring now to FIGS. 1-2 and 10A-10B, the trolley 26 is supported by the trolley portion 22b of the robot carriage 22 and, as shown, is preferably suspended from the trolley portion 22b vertically between the rail 20 and the blow side BLS of the IS forming machine 14. The trolley 26 includes a frame 88, a lower platform 90 carried by the frame 88, and an upper platform 92 carried by the frame 88, as shown best in FIG. 10A. The trolley 26 also includes a spray tool docking station 94 that is carried, for example, on the upper platform 92 of the trolley 26. The spray tool docking station 94 is located within an operational envelope of the robot 24 so that the robot 24 can acquire and release the mold spray tool 54 from and to the docking station 94, respectively, as well as one or more other mold spray tools if such additional tool(s) are present. Although the trolley 26 of the illustrated robotic mold lubrication system 10 shown here translates along the rail 20 in conjunction with the robot 24—this is because the robot and trolley portions 22a, 22b of the robot carriage 22 are connected—in other embodiments, the spray tool docking station 94 may be disconnected from the robot 24 and maintained in a fixed location on the rail 20, on a factory floor, on a machine, or on some other structure, and any conduits and cables that extend between the fixed location and the robot 24 can be carried by the utility chain 28. The trolley 26 may also carry certain hydraulic and pneumatic equipment of the robotic mold lubrication system 10 as described in more detail below.

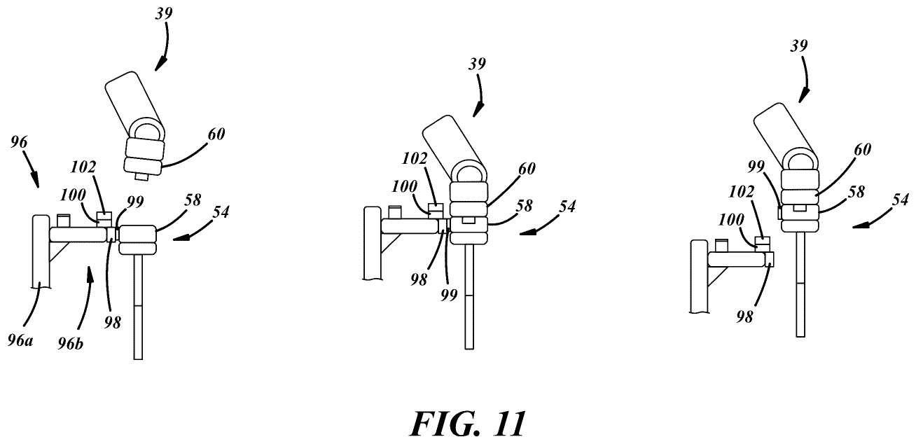

The spray tool docking station 94 includes a support stanchion 96 having a post 96a and one or more docks 96b, 96c as shown best in FIG. 10A. The post 96a projects vertically upward from the upper platform 92 of the trolley 26 and each of the docks 96b, 96c is coupled to the post 96a by triangular shaped brackets. Each of a first dock 96b and a second dock 96c may retain one mold spray tool 54 such that multiple of the mold spray tools 54 can be available to the robot 24. Although two docks 96b, 96c are illustrated as part of the support stanchion 96 shown here, one, three, or any other suitable quantity of docks may be coupled to the post 96a depending on the number of the mold spray tools 54 desired to be carried by the spray tool docking station 94. Also, multiple posts 96a with one or more docks may be used. The spray tool docking station 94 may further include an RFID reader 98 for each dock 96b, 96c. Each of the docks 96b, 96c, for example, may carry one RFID reader 98 via a bracket that is appended to the dock 96b, 96c, and the RFID reader 98 on each dock 96b, 96c may read an RFID tag 99 carried on a side of the tool coupler 58 of the mold spray tool 54 that is docked at the spray tool docking station 94 to identify the mold spray tool 54. Additionally, for each of the docks 96b, 96c, the spray tool docking station 94 may include a tool presence sensor 100 (FIG. 11) to sense the presence of the mold spray tool 54 at the dock 96b, 96c and a robot presence sensor 102 (FIG. 11) to sense the presence of the robot 24 in proximity to the dock 96b, 96c. The presence sensors 100, 102 may be carried on the docks 96b, 96c similar to the RFID reader 98 and may be proximity sensors that sense metal material of the tool and robot couplers 58, 60.

A plurality of the mold spray tools 54 can be retained at the spray tool docking station 94 for use by the robot 24. For example, as shown in FIG. 10A, a first mold spray tool 54a is retained on the first dock 96b and a second mold spray tool 54b, which is shown being carried by the robot 24, may be retained on the second dock 96c when the second mold spray tool 54b is returned to the spray tool docking station 94. The first mold spray tool 54a may be configured for spraying a lubricant on a first blow mold and the second mold spray tool 54b may be configured for spraying a lubricant on a second blow mold. To illustrate, the first mold spray tool 54a may be configured to spray a lubricant onto the interior surface of the bottom plate P (FIG. 5B) of the first blow mold with the bottom nozzle 62c and to also spray the lubricant onto the interior surfaces of the opposed first and second blow mold halves Ha, Hb (FIG. 5B) within the shoulder portions of the blow mold halves Ha, Hb with the left and right nozzles 62a, 62b, respectively. In contrast, the second mold spray tool 54b may be configured to spray a lubricant onto the interior surface of the bottom plate P of the second blow mold with the bottom nozzle 62c and to also spray the lubricant onto the interior surfaces of the blow mold halves Ha, Hb of the second blow mold over decorative finishing contours with the left and right nozzles 62a, 62b, respectively. In another example, the first and second mold spray tools 54a, 54b may be configured for spraying a lubricant on the same blow mold but at different portions of the blow mold. The first and second mold spray tools 54a, 54b may, for instance, be configured to spray a lubricant according to a different spray pattern onto different portions of the interior surfaces of the opposed blow mold halves Ha, Hb.

Referring now to FIG. 1, the robotic mold lubrication system 10 may further include an offline station 46 positioned proximate to one end of the rail 20 longitudinally beyond the individual sections 18 of the IS forming machine 14. The robot carriage 22 with the robot 24 and the trolley 26 can be parked at the offline station 46 away from the operating individual sections 18 for any reason including maintenance, calibration, or scheduled downtime. The offline station 46 may have calibration equipment 48 that includes one or more dummy blow molds 50 that open and close like an operating blow mold M but do not receive glass. Each of the dummy blow molds 50 includes opposed first and second dummy blow mold halves 50a, 50b and a dummy bottom plate 50c, actuators 51 to open and close each dummy blow mold 50, and one or more calibration sensors 52 in the form of, for example, cameras to capture images of the robot 24 spraying the dummy blow mold(s) 50, and/or thermal sensors. The robot 24 may be moved to the offline station 46 and may be operated to spray the dummy blow mold(s) 50 to calibrate operation of the mold spray tool 54 while the individual sections 18 of the IS forming machine are operating, thus helping to minimize downtime of the IS forming machine 14. The mold spray tool 54 can be calibrated at the offline station 46, which may include spraying the dummy blow mold 50 with the mold spray tool 54 and adjusting one or more spray parameters of the mold spray tool 54 based on an observation of the spraying of the dummy blow mold 50. The spray parameter(s) that may be adjusted include the movement path of the spray tool 54 and, for each nozzle 62a, 62b, 62c, the spray pattern, spray pressure, spray flow rate, spray timing, and nozzle orientation.

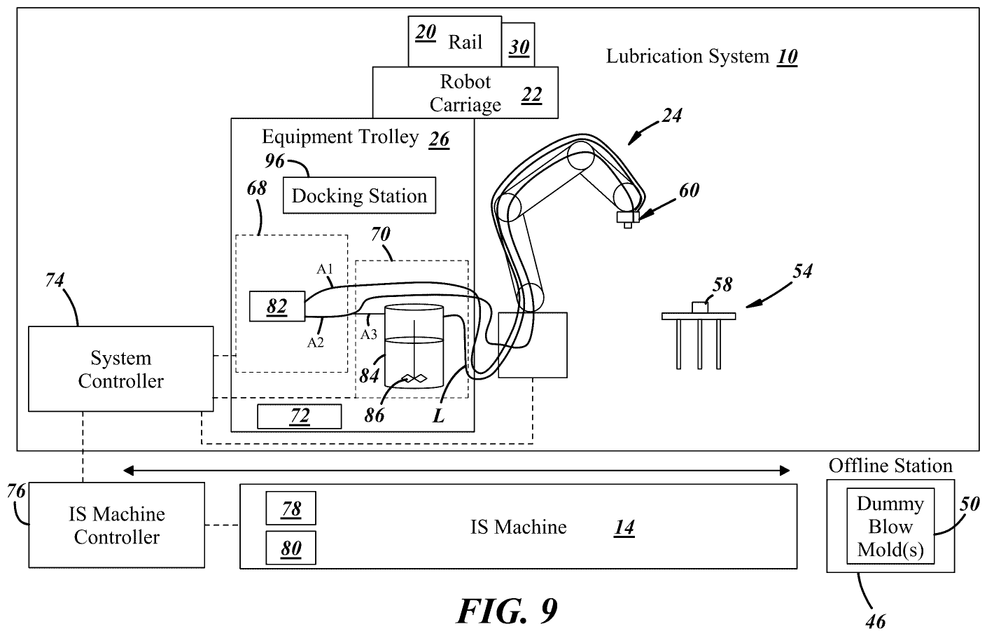

The robotic mold lubrication system 10 includes a pneumatic subsystem 68, a hydraulic subsystem 70, and a lubrication system controller 74, as shown schematically in FIG. 9, to support the blow mold lubrication operation. The lubrication system controller 74 may be in communication with an IS forming machine controller 76 that is also in communication with (i) one or more actuators 78 of the IS forming machine 14 such as mold actuators that open and close the blow mold halves Ha, Hb of each blow mold M (FIG. 5B), and (ii) one or more sensors 80 of the IS forming machine 14 such as position sensors and/or switches that indicate position of the blow mold halves Ha, Hb and the bottom plate P of each blow mold M during operation of the associated individual sections 18 of the IS forming machine 14. The pneumatic subsystem 68 includes a pressurized air source 82 that supplies pressurized air such as, for example, factory pressurized air or an air compressor. The pneumatic subsystem 68 further includes a plurality of air control valves 72, which, preferably, are electrovalves. The air control valves 72 may be included in one or more valve terminal electrical modules (VTEMs) to provide an interface between the actuators of the air control valve(s) 72 and the lubrication system controller 74 for precise air flow monitoring and control. At least some of the pneumatic subsystem 68 may be carried on the trolley 26. An air compressor operating as the pressurized air source 82 and at least some of the air control valves 72 may be carried, for instance, on the lower platform 90 of the trolley 26 as shown in FIGS. 10A-10B.

The hydraulic subsystem 70 includes a lubricant tank 84 having a mixer 86 to ensure consistent lubricant mixture quality. As shown in FIGS. 10A-10B, the lubricant tank 84 includes a tank body 84a and a tank cover 84b that is used to close off a volume of the tank body 84a that holds the lubricant. The lubricant tank 84 is preferably a pressurized tank that supplies lubricant to the robot 24 through a lubricant line L (FIG. 9). Other hydraulic equipment may be disposed on top of the tank cover 84b including, for example, a safety valve, pressure reducers, a filler cap, and various connection fittings. The mixer 86 of the lubricant tank 84 may be an air motor stirrer, for example, a pneumatic mixer, or a hand stirrer. Although not necessarily separately shown, the hydraulic subsystem 70 also may include a heater to adjust the viscosity of the lubricant in the lubricant tank 84, level sensors to sense high and low lubricant levels in the tank 84, flow control mechanisms, and lights (e.g. LEDs) and/or screens (e.g. LCDs) for temperature or level sensor indication. The heater, if present, may include temperature-regulated heating elements in the tank cover 84b or an in-tank heater. At least some of the hydraulic subsystem 70 may be carried on the trolley 26. Indeed, as shown in FIGS. 10A and 10B, the lubricant tank 84 may be carried on the lower platform 90 of the trolley 26, and the pressurized air source 82 of the pneumatic subsystem 68 may be used to pressurize the lubricant tank 84.

The pressurized air source 82 provides pressurized air to the robot coupler 60 through a pneumatic activation line A1 and a pneumatic atomization line A2 (FIG. 9). The pneumatic atomization line A2 provides stable pressurized air to the robot coupler 60 for entraining lubricant and discharging the lubricant from the nozzle(s) 62a, 62b, 62c of the mold spray tool 54 as a lubricant spray. The pneumatic activation line A1 provides pressurized trigger air to the robot coupler 60 to trigger lubricant actuators on the tool coupler 58 and/or on the mold spray tool 54 that, when actuated, permit lubricant to flow into the nozzles 62a, 62b, 62c of the mold spray tool 54 to mix with pressurized air from the pneumatic atomization line A2, thus forming the lubricant spray, as explained in more detail below. The selective application of pressurized air to the robot coupler 60 through each of the pneumatic activation line A1 and the pneumatic atomization line A2 is controlled by the one or more of air control valves 72 as instructed by the lubrication system controller 74. Moreover, the pressurized air source 82 may provide pressurized air to the lubricant tank 84 through a pressurizing line A3 (FIG. 9) that branches off of the pneumatic atomization line A2 upstream of the lubricant tank 84 to pressurize the lubricant tank 84 and to drive the mixer 86. The pneumatic activation, pneumatic atomization, and lubricant lines A1, A2, L may be routed to the robot coupler 60 through any suitable internal passage(s) of the robot 24.

The lubrication system controller 74 is in communication with and controls the pneumatic subsystem 68, the hydraulic subsystem 70, and various other portions of the robotic mold lubrication system 10 including the carriage motor 30 that drives the robot carriage 22, the robot 24, and the tool and robot couplers 58, 60. The lubrication system controller 74 also may be in communication with the IS forming machine controller 76 and the portions of the robotic mold lubrication system 10 via one or more local area networks (LAN), controller area networks (CAN), or any other network. Each of the controllers 74, 76 may include memory and a processor configured to execute instructions stored in the memory or entered through a command prompt. The lubrication system controller 74 may receive data or signals, machine states, and/or instructions from the IS forming machine 14 either directly or through the IS forming machine controller 76, may receive input data and instructions from a user via a user interface or from another controller, and/or may receive signals from other portions of the robotic mold lubrication system 10. The lubrication system controller 74 may process such received input and transmit output signals to other portions of the robotic mold lubrication system 10 including the carriage motor 30, the robot 24, the air control valve(s) 72, and/or other portions of the pneumatic and hydraulic subsystems 68, 70.

In a typical scenario, the lubrication system controller 74 may determine that a lubrication cycle has been requested for a designated individual section 18 of the IS forming machine 14. A lubrication cycle may be a subroutine of an overall IS forming machine program that is automatically initiated by the IS forming machine controller 76, for instance, after a certain quantity of machine cycles or a specific timeframe has elapsed, and/or the lubrication cycle may be a standalone program that may be initiated manually. During the lubrication cycle, the system controller 74 instructs the robot carriage 22 to travel along the rail 20 to bring the robot 24 into operating proximity with the designated individual section 18 for which the lubrication cycle has been requested. The system controller 74 also instructs the robot 24 to acquire the mold spray tool 54 for the designated individual section 18, as described in more detail below, in the event the robot 24 has not already acquired the correct mold spray tool 54. The system controller 74 then instructs the robot 24 to move the mold spray tool 54 to the target blow mold(s) M of the designated individual section 18 and to lubricate the blow mold(s) M by applying a lubricant, preferably as a lubricant spray, to the interior surface of one or both of the blow mold halves Ha, Hb and/or to the interior surface of the bottom plate P of each blow mold M. The lubrication cycle can be repeated for each of the other individual sections 18 if requested.

As part of the lubrication cycle for the designated individual section 18, the mold spray tool 54 may be calibrated. During calibration, the system controller 74 may instruct the robot carriage 22 to travel along the rail 20 to bring the robot 24 to the offline station 46 prior to arriving at the designated individual section 18 so that the mold spray tool 54 can be calibrated without interfering with the production of glass containers at the individual sections 18. The mold spray tool 54 may be acquired by the robot 24 before, during, or after movement of the robot 24 to the offline station 46 depending on how the calibration procedure is constructed. Once the robot 24 is at the offline station 46, the system controller 74 may instruct the robot 24 to lubricate the dummy blow mold 50 by applying a lubricant, preferably a lubricant spray, to the interior surface of one or both of the dummy blow mold halves 50a, 50b and/or to the interior surface of the dummy bottom plate 50c consistent with how the target blow mold M of the designated individual section 18 is to be lubricated. In this way, the operation of the robot 24 and the mold spray tool 54 can be observed and calibrating adjustments to the robotic mold lubrication system 10 can be made prior to the robot 24 arriving at the designated individual section 18 including, for example, adjustments to the operation of the mold spray tool 54 such as adjustments to spray patterns, spray pressure, spray flow rate, spray timing, nozzle position, and/or nozzle speed.

FIG. 11 schematically illustrates the robot 24 acquiring the mold spray tool 54 from the spray tool docking station 94 of the trolley 26. The mold spray tool 54 is shown (left illustration) retained on one of the docks 96b of the spray tool docking station 94 and, when so retained, the tool presence sensor 100 sends a signal to the lubrication system controller 74 (FIG. 9) indicating that the mold spray tool 54 is docked in place. After a command is sent to the lubrication system controller 74 to retrieve the mold spray tool 54, the robotic arm 39 carries the robot coupler 60 to the spray tool docking station 94 and positions the robot coupler 60 over the mold spray tool 54. The robotic arm 39 advances the robot coupler 60 towards the tool coupler 58 of the mold spray tool 54 and couples to robot and tool couplers 60, 58 together (middle illustration). Upon coupling, the robot presence sensor 102 carried by the spray tool docking station 94 is activated and sends a robot coupler presence signal to the lubrication system controller 74 indicating that the mold spray tool 54 has been engaged by the robotic arm 39, and the RFID reader 98, which reads the RFID tag 99 on the mold spray tool 54, sends an RFID signal identifying the spray tool 54 to the system controller 74. If the lubrication system controller 74 validates the coupling, the system controller 74 instructs the robot 24 to move the mold spray tool 54 away from the spray tool docking station 94 (right illustration) and sends signals to the appropriate air control valve(s) 72 to allow lubricant to be supplied to the robot coupler 60 from the lubricant line L and eventually to the tool coupler 58 and the mold spray tool 54. Once the mold spray tool 54 has been removed from the spray tool docking station 94, the tool presence sensor 100 indicates that the dock 96b is empty and available to retain the mold spray tool 54 in the future.

The robot coupler 60 on the robotic arm 39 of the robot 24 and the tool coupler 58 of the mold spray tool 54 may be coupled in any manner although, preferably, the couplers 60, 58 have complimentary quick connect/disconnect features as shown in FIG. 12. As shown, for example, the robot coupler 60 may have a cylindrical shaft 103 that carries retractable balls 104 and the tool coupler 58 may have a cylindrical socket 106 into which the shaft 103 is inserted. The cylindrical socket 106 defines a circumferentially extending groove 108 into which the retractable balls 104 can outwardly protrude to establish a quick connect/disconnect coupling between the tool and robot couplers 58, 60. The retractable balls 104 may be actively pneumatically actuated, passively mechanically actuated, or actuated in any other suitable manner. In the case of pneumatic actuation, one or more suitable valves, flow paths, and/or coupler passages may be used to control air pressure to the retractable balls 104 to retract and/or advance the retractable balls 104. The robot coupler 60 may also have a dowel hole 110 and the tool coupler 50 may have a dowel pin 112 that fits into the dowel hole 110 to locate the couplers 58, 60 with respect to one another upon coupling. In an alternate arrangement, the shaft 103 and dowel pin 112 and the socket 106 and the dowel hole 110 may be reversed between the robot coupler 60 and the tool coupler 58 as an equivalent to the illustrated arrangement.

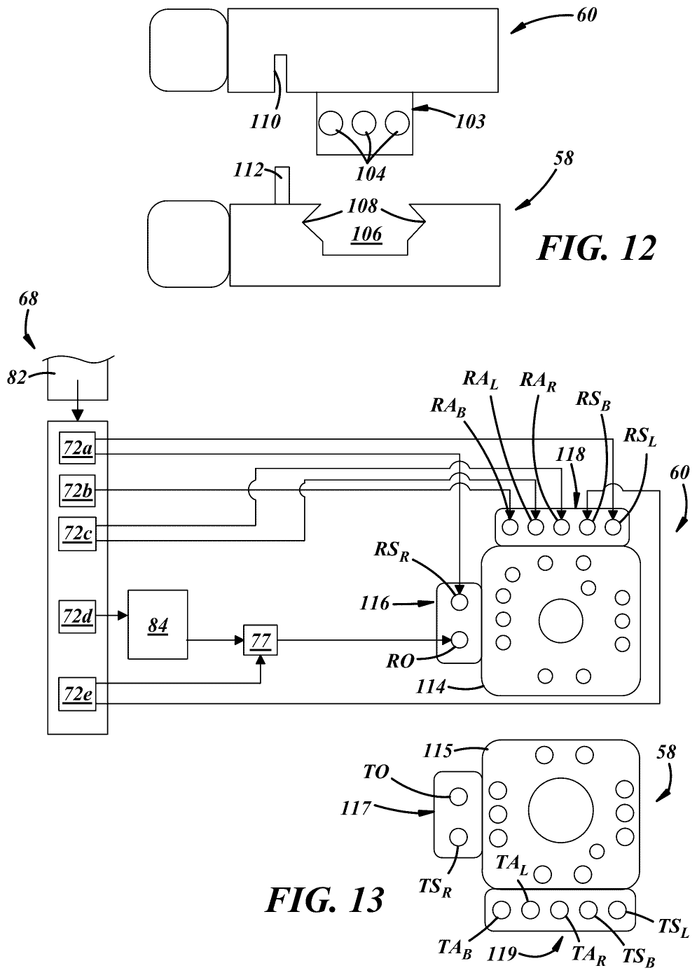

Additionally, and with reference to FIG. 13, each of the robot and tool couplers 60, 58 has a main body 114, 115, a first fluid transfer interface 116, 117 that may be carried at one side of the main body 114, 115 and in fluid communication therewith, and a second fluid transfer interface 118, 119 that may be carried at another side of the main body 114, 115 and in fluid communication therewith. Together, the main body 114, 115 and the first and second fluid interfaces 116, 117, 118, 119 establish a lubricant channel for receiving lubricant from the lubricant line L and supplying the lubricant to the mold spray tool 54 and, additionally, establish several pneumatic channels for receiving pressurized air from the pneumatic activation line A1 and the pneumatic atomization line A2. More specifically, the robot coupler 60 includes three pneumatic atomization passages that communicate with the pneumatic atomization line A2: a first atomization passage RA_{L} for the left nozzle 62a, a second atomization passage RA_{R} for the right nozzle 62b, and a third atomization passage RA_{B} for the bottom nozzle 62c. The robot coupler 60 also includes three pneumatic spray activation passages that communicate with the pneumatic activation line A1: a first spray activation passage RS_{L} for the left nozzle 62a, a second spray activation passage RS_{R} for the right nozzle 62b, and a third spray activation passage RS_{B} for the bottom nozzle 62c. The robot coupler 60 further includes a lubricant passage RO that receives lubricant from the lubricant tank 84 through the lubricant line L.

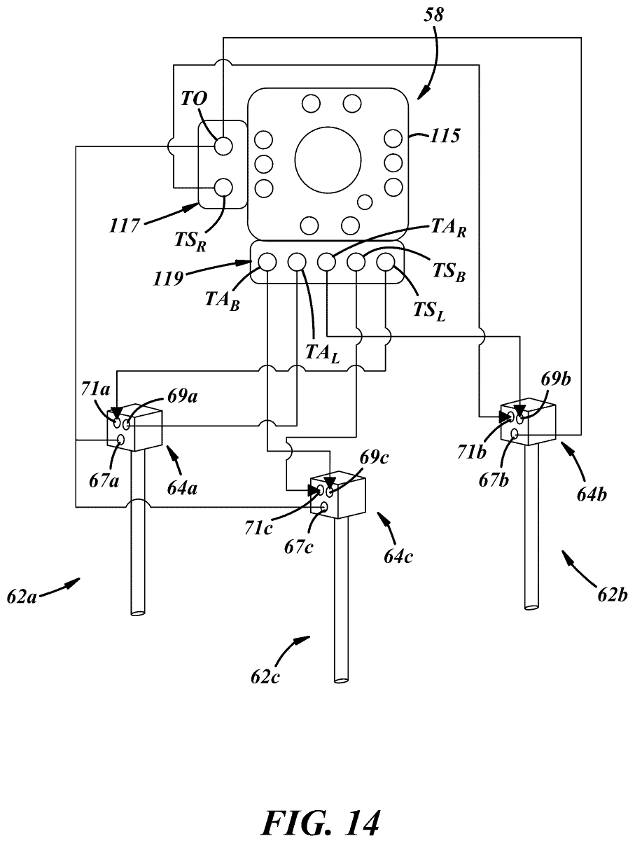

The tool coupler 58 of the mold spray tool 54 includes first, second, and third pneumatic atomization passages TA_{L}, TA_{R}, TA_{B}, first, second, and third pneumatic spray activation passages TS_{L}, TS_{R}, TS_{B}, and a lubricant passage TO that correspond and communicate with the atomization passages RA_{L}, RA_{R}, RA_{B}, the pneumatic spray activation passages RS_{L}, RS_{R}, RS_{B}, and the lubricant passage RO of the robot coupler 60, respectively, as shown in FIGS. 13-14. When the robot and tool couplers 60, 58 are coupled together, each pair of corresponding pneumatic atomization passages RA_{L}-TA_{L}, RA_{R}-TA_{R}, RA_{B}-TA_{B} respectively establishes a first (or left), a second (or right), and a third (or bottom) pneumatic atomization channel through the couplers 58, 60 and each pair of corresponding pneumatic spray activation passages RS_{L}-TS_{L}, RS_{R}-TS_{R}, RS_{B}-TS_{B} respectively establishes a first (or left), a second (or right), and a third (or bottom) pneumatic spray activation channel through the couplers 58, 60. Likewise, the corresponding lubricant passages RO-TO establish a lubricant channel across the couplers 58, 60. As shown in FIG. 14, the lubricant channel RO-TO established by the couplers 60, 58 communicates with the lubricant inlet port 67a, 67b, 67c of each nozzle valve 64a, 64b, 64c of the mold spray tool 54. Moreover, the first, second, and third pneumatic atomization channels RA_{L}-TA_{L}, RA_{R}-TA_{R}, RA_{B}-TA_{B} communicate with the atomizing air inlet port 69a, 69b, 69c, respectively, and the first, second, and third pneumatic spray activation channels RS_{L}-TS_{L}, RS_{R}-TS_{R}, RS_{B}-TS_{B} communicate with the activation air inlet port 71a, 71b, 71c, respectively.

To operate the mold spray tool 54, and for each of the sets of nozzles 62 carried by the mold spray tool 54, lubricant is supplied to each nozzle valve 64a, 64b, 64c through the lubricant channel RO-TO established by the couplers 60, 58. When spraying is desired through any one of the nozzles 62a, 62b, 62c, pressurized air is supplied through the applicable pneumatic atomization channel(s) RA_{L}-TA_{L}, RA_{R}-TA_{R}, RA_{B}-TA_{B}, which provides a flow of pressurized air through the associated nozzle 62a, 62b, 62c and out of the distal spray tip 65a, 65b, 65c. At the same time, pressurized air is supplied through the corresponding pneumatic spray activation channel(s) RS_{L}-TS_{L}, RS_{R}-TS_{R}, RS_{B}-TS_{B}, which actuates a lubricant actuator and permits lubricant to flow into the nozzle 62a, 62b, 62c where the lubricant is dispersed into the pressurized air flowing through the nozzle 62a, 62b, 62c to create the lubricant spray that is discharged from the nozzle 62a, 62b, 62c. The air control valve(s) 72 may be operated to control the lubricant spraying function of each of the nozzles 62a, 62b, 62c of the one or more sets of nozzles 62 carried on the mold spray tool 54. For instance, and referring specifically to FIG. 13, the air control valves 72 may include a first air control valve 72a, a second air control valve 72b, a third air control valve 72c, a fourth air control valve 72d, and a fifth air control valve 72e. Each of the valves 72a, 72b, 72c, 72d, 72e is controlled by the lubrication system controller 74 and is preferably an electrovalve.

Each of the nozzles 62a, 62b, 62c is independently controllable by the air control valves 72a, 72b, 72c, 72d, 72e and the lubricant spray can be discharged from one, two, or all three nozzles 62a, 62b, 62c as desired. When the mold spray tool 54 is coupled to the robot 24 via the robot and tool couplers 60, 58, the second and third air control valves 72b, 72c may be actuated to selectively supply pressurized air to the first, second, and third pneumatic atomization passages RA_{L}, RA_{R}, RA_{B} of the robot coupler 60 and then to the first, second, and third pneumatic atomization passages TA_{L}, TA_{R}, TA_{B} of the tool coupler 58. The second and third air control valves 72b, 72c are therefore actuatable to selectively supply pressurized air to any one or more of the pneumatic atomization channels RA_{L}-TA_{L}, RA_{R}-TA_{R}, RA_{B}-TA_{B}. Furthermore, the first and fifth air control valves 72a, 72e may be actuated to selectively supply pressurized air to the first, second, and third pneumatic spray activation passages RS_{L}, RS_{R}, RS_{B} of the robot coupler 60 and then to the first, second, and third pneumatic spray activation passages TS_{L}, TS_{R}, TS_{B} of the tool coupler 58 as needed to supply air through one or more of the pneumatic spray activation channels RS_{L}-TS_{L}, RS_{R}-TS_{R}, RS_{B}-TS_{B} and thus permit lubricant to flow into the associated nozzle(s) 62a, 62b, 62c. Still further, the fourth air control valve 72d may be actuated to supply pressurized air to the lubricant tank 84 and the fifth air control valve 72e may be actuated to open a lubricant supply valve 77, which is positioned in the lubricant line L downstream of the lubricant tank 84, to supply lubricant from the lubricant tank 84 to the lubricant channel RO-TO.

To minimize leaks, the robot coupler 60 includes seals, e.g., o-rings and/or gaskets, for every passage RA_{L}, RA_{R}, RA_{B}, RS_{L}, RS_{R}, RS_{B}, RO that communicates fluid, and a spring-loaded sealed port (not separately shown) to passively close at least the lubricant passage RO upon decoupling of the tool coupler 58 from the robot coupler 60. The first fluid transfer interface 116 of the robot coupler 60 (or “robot coupler first interface”) includes a housing and a spring-loaded sealed port for at least the lubricant passage RO, and the first fluid transfer interface 117 of the tool coupler 58 (or “tool coupler first interface”) includes a corresponding housing and a sealed port that engages and displaces the spring-loaded sealed port of the robot coupler first interface 116. In this way, the lubricant channel RO-TO can be established by engagement of the spring-loaded sealed port of the robot coupler first interface 116 and the sealed port of the tool coupler first interface 117 when the fluid transfer interfaces 116, 117 are brought together. When the tool and robot couplers 58, 60 are uncoupled and the first fluid transfer interfaces 116, 117 are separated, the sealed port of the tool first interface 117 disengages from the spring-loaded sealed port of the robot coupler first interface 116 and the spring-loaded sealed port self-seals to prevent lubricant from leaking out of the lubricant passage RO of the robot coupler 60. Any of a variety of known sealed and spring-loaded sealed ports may be implemented on the robot coupler 60 including a “blind-mate” quick-disconnect connector as the spring-loaded sealed port.

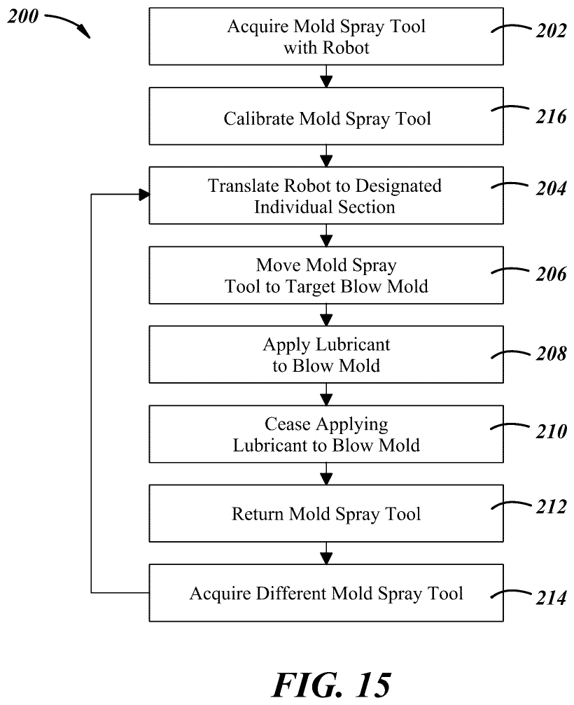

The robotic mold lubrication system 10 may be operated to execute a mold lubricating method 200 in which one or more blow molds M of one or more individual sections 18 of the IS forming machine 14 are lubricated, as set forth in FIG. 15. The mold lubricating method 200 is described in the context of using the robotic mold lubrication system 10 described above and shown in FIGS. 1-14, although the method 200 may be practiced with other systems not shown or described herein. The mold lubricating method 200 includes a variety of steps 202-216, some or all of which may be performed sequentially with respect to other steps and/or simultaneously with one or more other steps, and will be described in conjunction with FIGS. 1-14. The mold lubricating method 200 is automated and involves lubricating one or more blow molds M and, more specifically, spraying the blow mold(s) M with the lubricant. An “automated” lubricating operation means that the lubricant is delivered to, and applied onto the interior surfaces of, the blow mold(s) M without hand manipulation of either the blow molds M or the mold spray tool 54 during application of the lubricant.

The mold lubrication method 200 involves operating the robot 24 to acquire the mold spray tool 54 (step 202), which may be one of several mold spray tools 54a, 54b that are available to the robot 24. Here, the robot 24 and, more particularly, the robotic arm 39 of the robot 24, is moved to the spray tool docking station 94 of the trolley 26, for instance, as part of a lubrication cycle that is communicated to the lubrication system controller 74. The robotic arm 39 is moved into the vicinity of the dock 96b, 96c in which the mold spray tool 54 is retained and the robot coupler 60 is coupled to the tool coupler 58 of the spray tool 54. Before such coupling occurs, at least the lubricant passage RO of the robot coupler 60 is sealed closed, as described above, and the lubrication controller 74 prevents the flow of lubricant to the lubricant passage RO by keeping the lubricant supply valve 77 closed. The trolley 26 that includes the spray tool docking station 94 and the robot 24 may be translated together along the various individual sections 18 of the IS forming machine 14 since, here, both the trolley 26 and the robot 24 are connected to the robot carriage 22, which in turn is moveable along the rail 20. In other embodiments, however, the robot 24 and the trolley 26 may be unconnected and may be translated along the rail 20 separately from each other. The acquisition of the mold spray tool 54 may be performed as the robot 24 is being translated to a designated individual section 18 that includes the blow mold(s) M targeted for lubrication, after the robot 24 arrives at the designated individual section 18, or prior to the robot 24 commencing movement toward the designated individual section 18.

Preparatory to acquiring the mold spray tool 54, the tool presence sensor 100 at the spray tool docking station 94 communicates a tool present signal to the lubrication system controller 74, which indicates to the lubrication system controller 74 that the mold spray tool 54 being held at the dock 96b, 96c is available. In addition, the RFID reader 98 at the spray tool docking station 94 communicates an RFID signal to the lubrication system controller 74, which contains the particulars about the mold spray tool 54, for example, the identity of the mold spray tool 54 by part number, model number, an internal descriptor, or some other identifying reference. If the RFID reader 98 does not successfully read the RFID tag 99 on the mold spray tool 54, or the wrong identifying information is read, the lubrication system controller 74 outputs an alarm signal and the robot 24 will not be permitted to acquire the tool 54. In some instances, however, a bypass mode may be programmed into the lubrication system controller 74 that allows an operator to bypass the need for a successful RFID read operation and still continue operating the robotic mold lubrication system 10 despite an unsuccessful RFID read attempt.

The successful coupling of the robot coupler 60 to the tool coupler 58 may be confirmed, for example, upon receipt of a tool not present signal (or lack of a tool present signal) from the tool presence sensor 100 at the spray tool docking station 94 after the robot 24 has moved the robot coupler 60 away from the dock 96b, 96c of the docking station 94 as indicated by the lack of a robot coupler presence signal from the robot presence sensor 102. If the robot 24 moves away from the dock 96b, 96c of the spray tool docking station 94 as indicated by the robot presence sensor 102, but the tool presence sensor 100 continues to transmit a tool present signal to the lubrication system controller 74, the coupling of the robot coupler 60 to the tool coupler 58 is determined to have been unsuccessful by the system controller 74. After successful coupling has been confirmed, lubricant is allowed to flow through the lubricant line L to the robot coupler 60 and, from there, to the tool coupler 58 and eventually to the mold spray tool 54. Prior to the robot 24 acquiring the mold spray tool 54, however, the robot 24 may be locked in an idle position if the tool presence sensor 100 indicates the absence of the mold spray tool 54 at the dock 96b, 96c from which the robot 24 has been commanded to retrieve the spray tool 54 or if the RFID reader 98 reveals an identification anomaly.

Either before or after the robot 24 acquires the mold spray tool 54, the robot 24 is translated along the IS forming machine 14 to the designated individual section 18 (step 204) where the lubrication of the one or more target blow molds M is to occur. For example, the robot 24 may move along the IS forming machine 14 to the designated individual section 18 from the offline station 46, from another individual section 18, or from any other location. The robot 24 moves when the lubrication system controller 74 activates the carriage motor 30 to move the robot carriage 22 along the rail 20 and bring the robot 24 to the designated individual section 18. Prior to the robot 24 arriving at the designated individual section 18, the mold spray tool 54 may be calibrated (step 216). The calibration procedure may include moving the robot 24 to the offline station 46 by driving the robot carriage 22 that supports the robot 24 along the rail 20 to that particular location. While at the offline station 46, the operation of the mold spray tool 54 may be calibrated by moving the mold spray tool 54 to the dummy blow mold(s) 50 by operation of the robotic arm 39 of the robot 24, spraying the dummy blow mold(s) 50 (e.g., spraying one or more of the first dummy blow mold half 50a, the second dummy blow mold half 50b, and the dummy bottom plate 50c), and adjusting one or more spray parameters of the mold spray tool 54 based on an observation of the spraying of the dummy blow mold(s) 50.

After the robot 24 has acquired the mold spray tool 54 and has arrived at the designated individual section 18, the mold spray tool 54 is moved by operation of the robotic arm 39 of the robot 24 to the target blow mold(s) M of the section 18 (step 206). Each of the target blow mold(s) M is preferably in the open position—meaning that the opposed first and second blow mold halves Ha, Hb are separated from one another and from the bottom plate P as shown in FIG. 5B—when the mold spray tool 54 is moved to the target blow mold(s) M. With the target blow mold(s) M open, the mold spray tool 54 is manipulated by the robotic arm 39 to position each of the one or more sets of nozzles 62 within one of the one or more target blow molds(s) M. The mold spray tool 54 is then activated to apply lubricant to each of the target blow mold(s) M (step 208). Specifically, the mold spray tool 54 applies the lubricant as a lubricant spray to one or more and, preferably, all of (i) the interior surface of the first or left blow mold half Ha, (ii) the interior surface of the second or right blow mold half Hb, and (iii) the interior surface of the bottom plate P. The mold spray tool 54 is activated to apply the lubricant from the nozzles 62a, 62b, 62c of each set of nozzles 62 by the lubrication system controller 74. As described above, the lubrication system controller 74 controls the flow of lubricant spray from each of the nozzles 62a, 62b, 62c by controlling the air control valve(s) 72 that manage the supply of lubricant, atomization pressurized air, and activation pressurized air to the mold spray tool 54. The mold spray tool 54 may be moved in a certain predefined movement pattern to relative to the blow mold(s) M to apply the lubricant onto the interior surfaces of the opposed blow mold halves Ha, Hb and the bottom plate P according to a prescribed lubricant coverage pattern.

The mold spray tool 54 is deactivated to cease applying the lubricant (step 210) once the target blow mold(s) M have been lubricated. The mold spray tool 54 is deactivated by the lubrication system controller 74, which, as explained above, controls the flow of lubricant spray from each of the nozzles 62a, 62b, 62c. In the event the blow mold(s) M of another or next individual section 18 of the IS forming machine 14 are to be lubricated, the robot 24 may be translated to the next individual section 18 to be lubricated by repeating step 204. After the robot 24 has been translated to the next individual section 18, the mold spray tool 54 may be moved to the target blow mold(s) M of the next individual section 18, activated to apply the lubricant to each of the target blow mold(s) M, and deactivated to cease applying the lubricant once the target blow mold(s) M have been lubricated by repeating steps 206-210. The same steps 204-210 of the mold lubrication method 200 can be repeated to lubricate the target blow mold(s) M of any or all of the remaining individual sections 18 of the IS forming machine 14.

After lubricating the blow mold(s) of each designated individual section 18, the mold spray tool 54 is returned to the spray tool docking station 94 (step 212). To return the mold spray tool 54, the robot 24 and, more particularly, the robotic arm 39 of the robot 24 while carrying the mold spray tool 54, is moved to the spray tool docking station 94 of the trolley 26 and into the vicinity of the dock 96b, 96c on which the mold spray tool 54 is to be returned. Once the mold spray tool 54 is at the selected dock 96b, 96c, the robot and tool couplers 60, 58 are decoupled and the mold spray tool 54 is released to the dock 96b, 96c. At this point, the tool presence sensor 100 at the docking station 94 communicates a tool present signal to the lubrication system controller 74, which indicates to the system controller 74 that the mold spray tool 54 is being retained at the dock 96b, 96c, and the RFID reader 98 at the docking station 94 reads the RFID tag 99 and communicates an RFID signal to the system controller 74 identifying the mold spray tool 54. The return of the mold spray tool 54 back to the spray tool docking station 94 may be performed at whatever location the robot 24 happens to be when the lubrication system controller 74 calls for a tool return. Alternately, the robot 24 may be translated along the IS forming machine 14 by moving the robot carriage 22 along the rail 20 to bring the robot 24 to a default or home position prior to returning the mold spray tool 54 to the spray tool docking station 94.

Since the spray tool docking station 94 may carry more than one mold spray tool 54, the robot 24 may acquire a different mold spray tool 54 (step 214) after the mold spray tool 54 previously acquired in step 202 has been returned to the docking station 94 in step 212. To acquire the different mold spray tool 54, the robot 24 and, more particularly, the robotic arm 39 of the robot 24, is moved to the spray tool docking station 94 of the trolley 26 in the vicinity of the dock 96b, 96c in which the different mold spray tool 54 is retained and the robot coupler 60 is coupled to the tool coupler 58 of the different mold spray tool 54. The mold spray tool 54 acquired here in step 214 is docked at a different dock 96b, 96c of the spray tool docking station 94 than the mold spray tool 54 previously acquired in step 202 and the coupling of the robot coupler 60 and the tool coupler 58 of the different mold spray tool 54 is carried out in the same way as previously described. Steps 204 to 210 of the mold lubricating method 200 are then repeated, multiple times if desired with the different mold spray tool 54 until the lubrication system controller 74 instructs the robot 24 to return the different mold spray tool 54 to the spray tool docking station 94 by repeating step 212. Of course, when repeating steps 204 to 210 with the different mold spray tool 54, the steps 204 to 210 may include slight variances compared to the same steps with the other mold spray tool 54 considering the differences in the mold spray tools 54 acquired in steps 202 and 214.

The mold spray tool 54 illustrated in FIGS. 5A-5B embodies one particular design that may be utilized by the robotic mold lubrication system 10. Other mold spray tool designs that include a support base and at least one set of nozzles carried by the support base may certainly be employed to achieve the same function, especially since the support base may assume a variety of configurations that are suitable to carry the tool coupler and the set(s) of nozzles apart from a planar plate. One such alternate mold spray tool is shown in FIGS. 5C-5D. There, another embodiment of a mold spray tool 254 to lubricate the one or more blow molds M in one or more individual sections 18 of the IS forming machine 14 (FIG. 1) is shown. The mold spray tool 254 includes a support base 256 and also includes the tool coupler 58 carried by support base 256 and at least one set of nozzles 262 carried by the support base 256. The tool coupler 58 of the mold spray tool 254 is couplable to the robot coupler 60 carried by the robotic arm 39, as before, and each set of nozzles 262 is in downstream fluid communication with the tool coupler 58. Also, as before, each set of the nozzles 262 may include a first or “left” nozzle 262a, a second or “right” nozzle 262b, and a third or “bottom” nozzle 262c.

The mold spray tool 254 depicted here is an end-supported or cantilevered spray tool as the tool coupler 58 is mounted at one end of the support base 256. In contrast, the mold spray tool 54 of FIGS. 5A-5B is a center-supported spray tool as the tool coupler 58 is mounted in a central location of the support base 56. The support base 256 of the mold spray tool 254 of FIGS. 5C-5D, more specifically, includes a coupler portion 257a, a nozzle carrying portion 257b spaced away and vertically offset from the coupler portion 257a, and a stepped portion 257c that extends downwardly from the coupler portion 257a to the nozzle carrying portion 257b and connects the coupler portion 257a to the nozzle carrying portion 257b. Because the support base 256 is stepped or offset, the nozzle carrying portion 257b of the support base 256 may be located deeper between the blow mold halves Ha, Hb, as depicted in FIG. 5D. This may allow, in some instances, the left and right nozzles 262a, 262b to be situated below corresponding shoulder portions of the mold halves Ha, Hb to help facilitate spraying of those portions of the mold halves Ha, Hb. Nonetheless, in the same way as before, and as shown in FIG. 5D, the bottom nozzle 262c of the mold spray tool 254 may be configured to spray an interior surface of the bottom plate P of the blow mold M with a lubricant while the left and right nozzles 262a, 262b may be configured to spray the interior surface of the left blow mold half Ha and the interior surface of the right blow mold half Hb of the blow mold M with a lubricant, respectively.

As used in herein, the terminology “for example,” “e.g.,” for instance,” “like,” “such as,” “comprising,” “having,” “including,” and the like, when used with a listing of one or more elements, is to be construed as open-ended, meaning that the listing does not exclude additional elements. Also, as used herein, the term “may” is an expedient merely to indicate optionality, for instance, of a disclosed embodiment, element, or feature, and should not be construed as rendering indefinite any disclosure herein. Finally, the subject matter of this application is presently disclosed in conjunction with several explicit illustrative embodiments and modifications to those embodiments, using various terms. All terms used herein are intended to be merely descriptive, rather than necessarily limiting, and are to be interpreted and construed in accordance with their ordinary and customary meaning in the art, unless used in a context that requires a different interpretation. The present disclosure is intended to embrace all embodiments and modifications of the subject matter of this application that fall within the scope of the accompanying claims.

1. A mold spray tool, comprising:
a support base; and
at least one set of nozzles carried by the support base, wherein the set of nozzles includes a first nozzle, a second nozzle, and a third nozzle.

2. The mold spray tool set forth in claim 1, wherein each of the first nozzle, the second nozzle, and the third nozzle includes an elongated nozzle body and a distal spray tip supported at an axial free end of the elongated nozzle body.

3. The mold spray tool set forth in claim 2, wherein the third nozzle is longer than the first and second nozzles and is positioned between the first and second nozzles.

4. The mold spray tool set forth in claim 1, wherein the at least one set of nozzles comprises a plurality of sets of nozzles.

5. The mold spray tool set forth in claim 1, further comprising a tool coupler carried by the support base and connectable to a robot.

6. The mold spray tool set forth in claim 5, wherein the set of nozzles extends from the support base opposite the tool coupler.

7. The mold spray tool set forth in claim 5, wherein the support base includes a planar plate that includes a coupler side and a nozzle side opposite the coupler side, and wherein the tool coupler is secured to the coupler side of the support base and the at least one set of nozzles extends away from the nozzle side of the support base.

8. The mold spray tool set forth in claim 5, wherein the support base includes a coupler portion, a nozzle carrying portion spaced away and vertically offset from the coupler portion, and a stepped portion that extends downwardly from the coupler portion to the nozzle carrying portion and connects the coupler portion to the nozzle carrying portion, and wherein the tool coupler is secured to the coupler portion and the set of nozzles is carried by and extends away from the nozzle carrying portion.

9. The mold spray tool set forth in claim 1, wherein the mold spray tool is configured so that a lubricant is independently controllably sprayable from each of the first nozzle, the second nozzle, and the third nozzle.

10. A robotic mold lubrication system, comprising:
a rail that is arranged above, and extends longitudinally along, a blow side of an individual section glass container forming machine;
a robot carriage carried on and moveable along the rail;
a robot carried by the robot carriage; and
a trolley carried by the robot carriage, the trolley including a spray tool docking station that retains at least one mold spray tool so that the robot can acquire the mold spray tool from the docking station and release the mold spray tool to the docking station.

11. The robotic mold lubrication system set forth in claim 10, wherein the robot is suspended from a robot portion of the robot carriage and the trolley is suspended from a trolley portion of the robot carriage, and wherein the robot portion of the robot carriage is connected to the trolley portion of the robot carriage.

12. The robotic mold lubrication system set forth in claim 10, wherein the robot carriage is driveable by a carriage motor.

13. The robotic mold lubrication system set forth in claim 10, wherein the spray tool docking station includes a stanchion having a dock that carries the mold spray tool.

14. The robotic mold lubrication system set forth in claim 13, wherein the dock carries an RFID reader and the mold spray tool carries an RFID tag that is readable by the RFID reader to identify the mold spray tool.

15. The robotic mold lubrication system set forth in claim 13, wherein the dock carries a tool presence sensor to sense the presence of the mold spray tool and a robot presence sensor to sense the presence of the robot in proximity to the dock.

16. The robotic mold lubrication system set forth in claim 10, wherein the robot includes a robotic arm that carries a robot coupler, and the mold spray tool includes a tool coupler, and wherein the robot coupler is couplable to a tool coupler of the mold spray tool.

17. The robotic mold lubrication system set forth in claim 16, wherein one of the robot coupler or the tool coupler has a shaft with retractable balls, and the other of the robot coupler or the tool coupler has a socket that defines a groove, and wherein the shaft of the robot coupler or the tool coupler is received into the socket of the other of the robot coupler or the tool coupler such that the retractable balls extend into the groove.

18. The robotic mold lubrication system set forth in claim 10, wherein the mold spray tool comprises a support base and at least one set of nozzles carried by the support base, wherein the set of nozzles includes a first nozzle, a second nozzle, and a third nozzle, and, further, when the robot coupler and the tool coupler are coupled together, a lubricant channel is established through the robot and tool couplers and is in fluid communication with the mold spray tool to supply lubricant to each of the first nozzle, the second nozzle, and the third nozzle.

19. The robotic mold lubrication system set forth in claim 18, wherein, additionally, when the robot coupler and the tool coupler are coupled together, a first pneumatic atomization channel, a second pneumatic atomization channel, and a third pneumatic atomization channel are established through the robot and tool couplers and are in fluid communication with the mold spray tool to supply pressurized atomization air to the first nozzle, the second nozzle, and the third nozzle, respectively.

20. The robotic mold lubrication system set forth in claim 10, further comprising a lubricant tank that is carried by the trolley, and wherein lubricant is supplied from the lubricant tank to the robot through a lubricant line.

21. The robotic mold lubrication system set forth in claim 10, further comprising:
an offline station positioned longitudinally beyond individual sections of the individual section glass container forming machine, the offline station including one or more dummy blow molds.

22. A robotic mold lubrication system, comprising:
a robot moveable along a blow side of an individual section glass container forming machine, the robot including a robotic arm that carries a robot coupler; and
a trolley that includes a spray tool docking station that retains at least one mold spray tool, the mold spray tool including a tool coupler and at least one set of nozzles, and wherein the robot coupler of the robot and the tool coupler of the mold spray tool are couplable so that the robot can acquire the mold spray tool from the docking station and release the mold spray tool to the docking station.

23. The robotic mold lubrication system set forth in claim 22, further comprising:
a rail arranged above, and extending longitudinally along, the blow side of the individual section glass container forming machine; and
a robot carriage carried on and moveable along the rail, and wherein the robot is carried by the robot carriage.

24. The robotic mold lubrication system set forth in claim 23, wherein the trolley is also carried by the robot carriage along with the robot.

25. The robotic mold lubrication system set forth in claim 22, wherein the spray tool docking station includes a stanchion having a dock that carries the mold spray tool, the dock carrying an RFID reader and the mold spray tool carrying an RFID tag that is readable by the RFID reader to identify the mold spray tool.

26. The robotic mold lubrication system set forth in claim 22, further comprising a lubricant tank that is carried by the trolley, and wherein lubricant is supplied from the lubricant tank to the robot through a lubricant line.

27. The robotic mold lubrication system set forth in claim 26, wherein, when the robot coupler and the tool coupler are coupled together, a lubricant channel and at least one pneumatic atomization channel are established through the robot and tool couplers and are in fluid communication with the mold spray tool, the lubricant channel supplying lubricant to the mold spray tool and the at least one pneumatic atomization channel supplying pressurized atomization air to the mold spray tool.

28. The robotic mold lubrication system set forth in claim 22, further comprising:
an offline station positioned longitudinally beyond individual sections of the individual section glass container forming machine, the offline station including one or more dummy blow molds.

29. A method of lubricating a blow mold of an individual section glass container forming machine, the method comprising:
operating a robot to acquire a mold spray tool that includes at least one set of nozzles;
translating the robot along a blow side of an individual section glass container forming machine to bring the robot to a designated individual section of the forming machine;
moving the mold spray tool by operation of the robot to a target blow mold at the designated individual section of the forming machine; and
applying a lubricant from the set of nozzles of the mold spray tool onto the target blow mold to lubricate the target blow mold.

30. The method set forth in claim 29, wherein applying a lubricant from the set of nozzles of the mold spray tool comprises:
discharging an atomized spray of lubricant from the set of nozzles to apply the lubricant to at least one of (i) an interior surface of a first blow mold half of the blow mold, (ii) an interior surface of a second blow mold half of the blow mold, which is opposed from the first blow mold half of the blow mold, or (iii) an interior surface of a bottom plate of the blow mold.

31. The method set forth in claim 29, wherein operating the robot to acquire the mold spray tool comprises:
moving a robotic arm of the robot to a trolley that includes a spray tool docking station where the mold spray tool is retained; and
coupling a robot coupler carried by the robotic arm to a tool coupler of the mold spray tool.

32. The method set forth in claim 29, wherein translating the robot along the blow side of the individual section glass container forming machine comprises:
moving a robot carrier along a rail that is arranged above, and extends longitudinally along, the blow side of an individual section glass forming machine, the robot being supported by the robot carrier.

33. The method set forth in claim 29, wherein moving the mold spray tool by operation of the robot to the target blow mold comprises:
positioning the set of nozzles within the target blow mold when the target blow mold is in the open position.

34. The method set forth in claim 29, further comprising:
translating the robot along the blow side of the individual section glass container forming machine to an offline station positioned longitudinally beyond individual sections of the individual section glass container forming machine, the offline station including a dummy blow mold; and
calibrating the mold spray tool at the offline station including applying a lubricant from the set of nozzles of the mold spray tool onto the dummy blow mold.

35. The method set forth in claim 29, further comprising returning the mold spray tool to the spray tool docking station.

36. The method set forth in claim 29, further comprising:
translating the robot along the blow side of the individual section glass container forming machine to bring the robot to another designated individual section of the forming machine;
moving the mold spray tool by operation of the robot to a target blow mold at the another designated individual section of the forming machine; and
applying a lubricant from the set of nozzles of the mold spray tool onto the target blow mold of the another designated individual section to lubricate the target blow mold of the another designated individual section.

37. A method of lubricating a blow mold of an individual section glass container forming machine, the method comprising:
moving a robotic arm of a robot to a trolley that includes a spray tool docking station at which a mold spray tool is retained, the mold spray tool comprising at least one set of nozzles, and the robot being carried by a robot carrier that is translatable along a rail arranged above, and extending longitudinally along, a blow side of an individual section glass forming machine;
coupling the mold spray tool to the robotic arm of the robot;
translating the robot along the blow side of the individual section glass container forming machine to bring the robot to a designated individual section of the forming machine;
moving the mold spray tool by operation of the robot to a target blow mold at the designated individual section of the forming machine to position the set of nozzles of the mold spray tool within the target blow mold when the target blow mold is in the open position;
applying a lubricant from the set of nozzles of the mold spray tool onto the target blow mold to lubricate the target blow mold; and
returning the mold spray tool to the spray tool docking station.
